(19) United States
(12) Patent Application Publication
(10) Pub. No.: US 2025/0072569 A1
(43) Pub. Date: Mar. 6, 2025

(54) Low Profile Key Fob

(71) Applicant: Michael Maggio, Oakland, CA (US)

(72) Inventor: Michael Maggio, Oakland, CA (US)

(21) Appl. No.: 18/490,749

(22) Filed: Oct. 19, 2023

Related U.S. Application Data
(60) Provisional application No. 63/579,453, filed on Aug. 29, 2023.

(51) Int. Cl. A44B 15/00; A45C 11/00

(52) U.S. Cl. CPC A44B 15/005; A45C 11/00; A45C 11/002

(57) ABSTRACT

A device and method for creatin a low profile key fob for combining with a cell phone case or a cell phone. A manufacturer's key fob is disassembled and its printed circuit board and battery are removed and inserted side by side into the low-profile housing along with interconnecting custom metal electrical contacts.

The low-profile key fob is attached to the rear panel of a specially designed cell phone case and/or cell phone. The resulting combination of the cell phone and/or cell phone case and the low-profile key fob allows a user to carry only one essential physical item on his or her person rather than two separate items, each retaining its original functionality and the two can be separated at will without losing any functionality.

### CROSS REFERENCE TO RELATED APPLICATIONS

Patent application Ser. No. 18/048,032 filing date Oct. 20, 2022
Patent Application 63/576,453

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of key fobs and more specifically to a device and method to enable a person to integrate the components of a key fob into a cell phone case.

The term “fob” originally referred to an ornament attached to a pocket-watch chain. The origin of the term “fob” goes back to either Middle English fobben, or German Fuppe (pocket) or the German foppen meaning sneak-proof. In modern times, the term fob has been assigned to the term “Key fob” which is able to be carried in ones pocket or purse and is used as a way to transmit a signal from the key fob to a vehicle that can allow the user of the vehicle to unlock or lock the vehicle or to allow the driver to press a start button on the dashboard to start the engine of the vehicle. Although key fobs create ease of use by eliminating the need to insert a physical key into an ignition switch or door lock, there is the chance that the car owner has lost or forgotten the key fob because it is a separate item that can be misplaced relatively easily. Lost or misplaced key fobs are cumulatively responsible for thousands of hours lost time and millions of dollars in payment for replacement fobs. It would therefore be beneficial if there was a way to integrate a key fob with another device that ninety-five percent of the population currently always carry with them. That device is the ever-present cell phone and associated cell phone case.

### BRIEF SUMMARY OF THE INVENTION

A unique device and method for integrating key fob electronics into a cell phone case, a cell phone attachment or as an attachment that can be attached directly to back of a phone. A standard key fob, which is issued with each new vehicle, is disassembled by either the owner of the vehicle or by a qualified technician such as a locksmith or auto dealer employee and reassembled into a unique low-profile housing that can be incorporated into the rear panel of a cell unique phone case.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process of disassembling a standard key fob by opening the plastic molded housing of the manufacture issued key fob and removing its components, including its PC board and battery, and then reconfiguring those components, along with custom battery contacts into a side by side format that allows the components to fit into a unique low-profile housing that can be inserted into a recessed area on the rear surface of a uniquely designed cell phone case thereby integrating the key fob feature with a cell phone case.

### BRIEF DESCRIPTION OF DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a section view of a standard key fob.

FIG. 2 is a section view of the present invention

FIG. 3 is an exploded view of the present invention.

FIG. 4 is a view of the present invention ready to be inserted into a novel cell phone case.

FIG. 5 is a perspective view of the present invention inserted in the novel cell phone case

FIG. 6 is a perspective view of two housings of the present invention inserted in the novel cell phone case.

FIG. 7 is an exploded view of an alternate embodiment present invention where self-adhesive flanges surround the housing.

FIG. 8 is a flow chart showing the sequence of events from converting a manufactured key fob to an integrated combination vehicle activating device and cell phone case.

FIG. 9 is an exploded view of alternate embodiment of the invention where a housing holder is attached to the back of a cell phone.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner. For example, the current invention discusses the attachment of a low-profile key fob to the back of a specially designed cell phone case, however the same concept can be applied to other types of carry cases or to other cell phone accessories that are meant to be carried along with a cell phone.

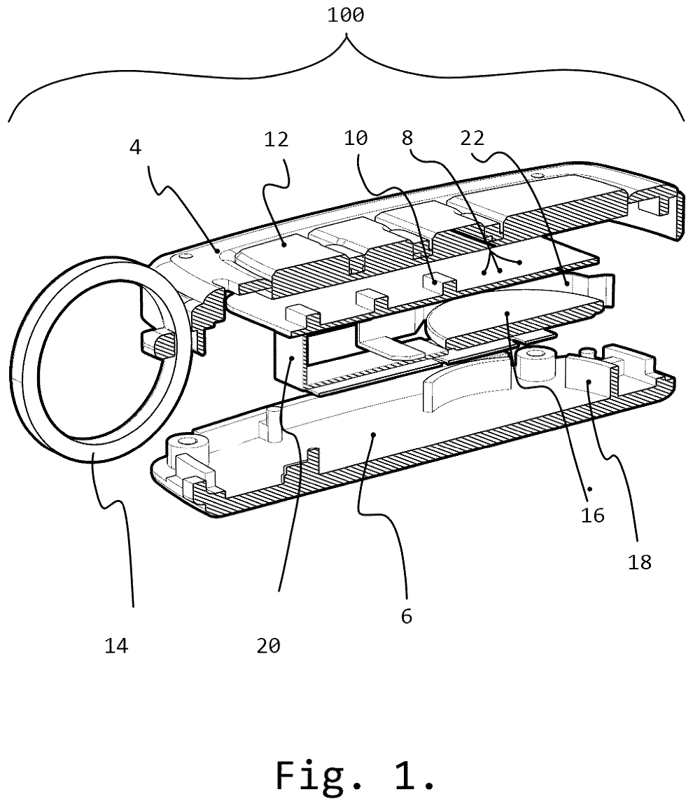

Referring now to FIG. 1 we see a side section view of a typical key fob 100. A plastic housing is comprised of upper housing 4 and lower housing 6. Within the housing 4,6 is a battery holder 18, a battery 16, battery contacts 20, 22 and a PC board 8. The PC board 8 includes a short-range transmitter component and a plurality of momentary switches 10 used for features such as actuating door locks. Integral flexible panels 12 on the outside of the top housing half 4 allow the user to push down on switches 10. The overall construction of the internal parts of fob 100 creates a relatively short length but a relatively large height due to the stacking of components 16, and 8.

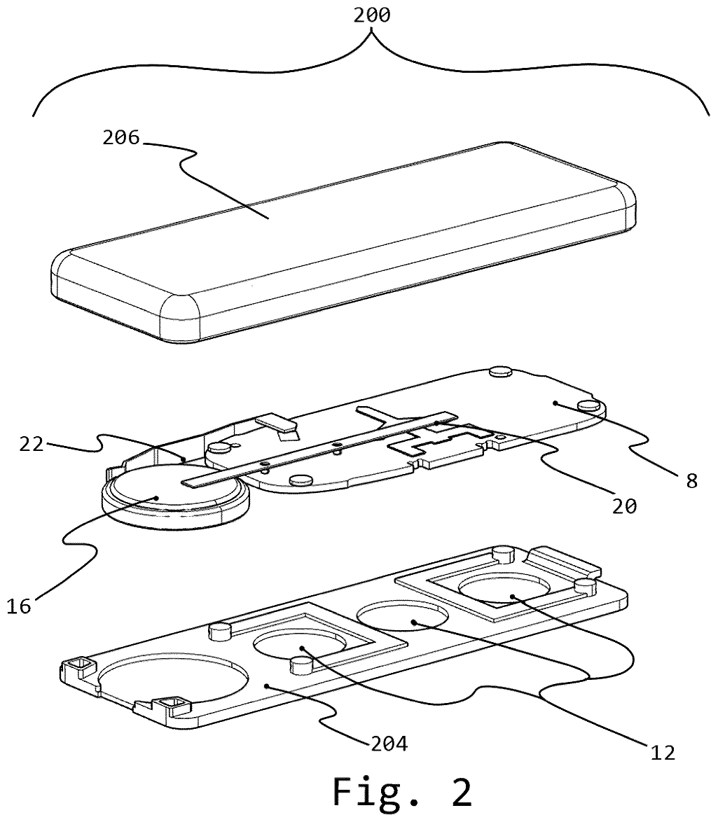

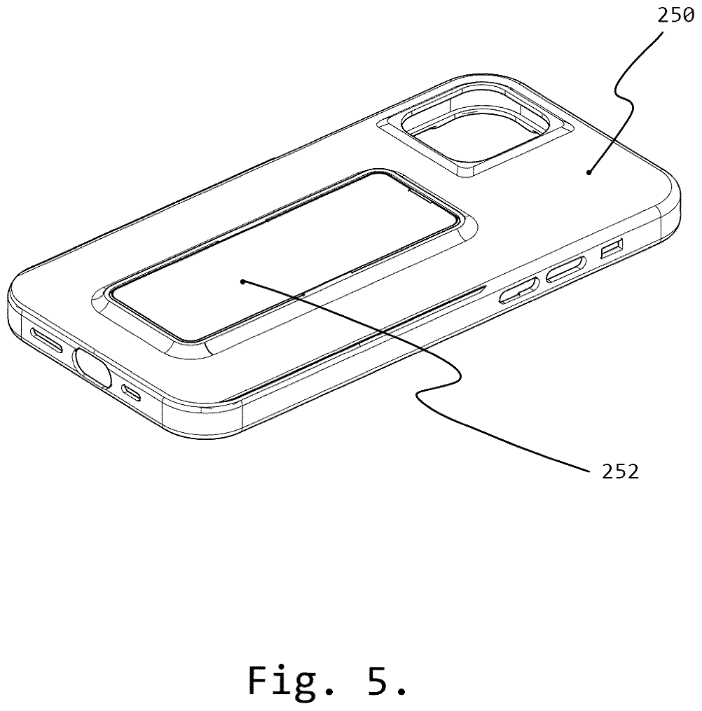

FIG. 2 is a side section view of enclosure 200 of the present invention. The housing is made of upper half 204 and lower half 206. In this embodiment, the same components 8, 16 used in the manufactures version of the fob are laid end to end thereby allowing for a smaller height dimension. This smaller height dimension allows the enclosure of the present invention 200 to be installed in a depression in a specially designed cell phone case 250 as shown in FIG. 5. Because of the reduced height of the housing 204, 206, the housing will not protrude excessively from the exterior of the cell phone case. The resulting design thereby integrates the cell phone case 250 with the vehicle control device components found in the manufacturer's key fob. It should be noted that each vehicle manufacturer has its own design for the fob PCB and therefore there will be variations in the PCB holding area within the bottom half 204 of the low-profile housing 200.

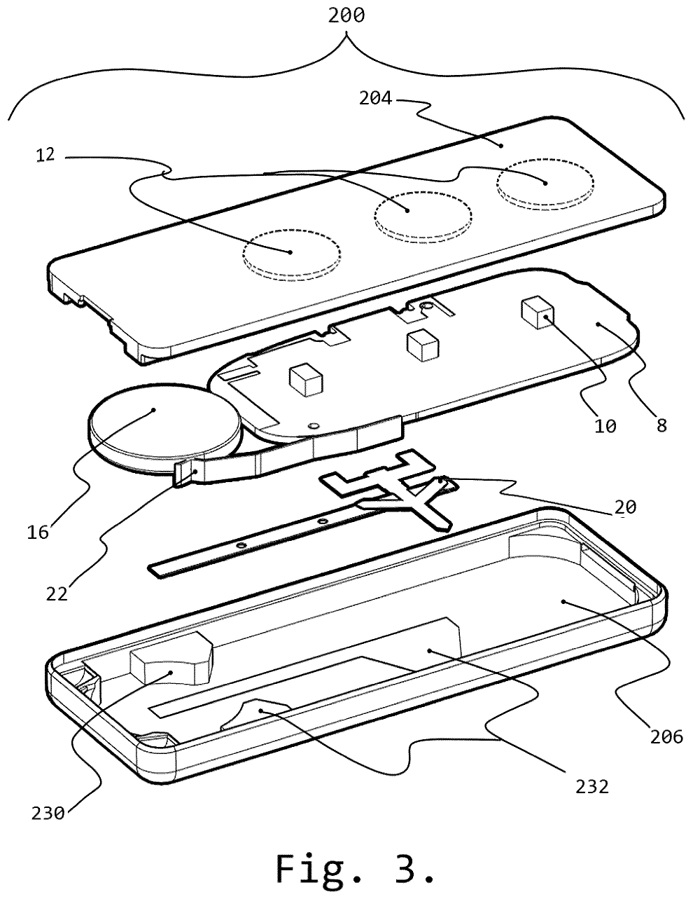

FIG. 3 is an exploded view of the housing and internal components present invention 200. The bottom half housing 206 includes a recess 230 for battery 16 and recesses 232 for battery connecting pieces 20, 22. Manufacturer's PC board 8 sits on the floor of bottom half housing 206. Top housing half 204 attaches to bottom half 206 by standard means such as a snap fit between the two halves. The top housing half 204 is mostly rigid except for portions depicted by dotted lines 12 which are flexible to allow the user to press down to activate switches 10 located on PC board 8.

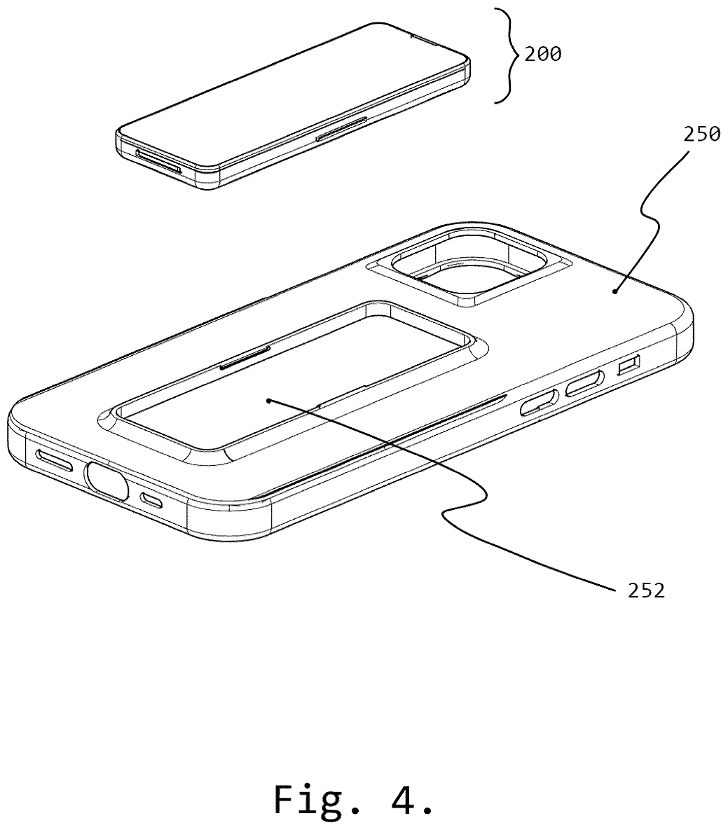

FIG. 4 is a perspective view of a specially designed cell phone case 250 which includes a recessed portion 252 in the rear panel that is similar in size to the dimensions of the housing of the present invention 200.

FIG. 5 is a perspective view showing the housing 200 fully installed into the rear panel of cell phone case 250. This configuration allows the user to carry only one essential item rather than two separate essential items and therefore reduces the chance of the vehicle controlling device 200 from being misplaced or lost.

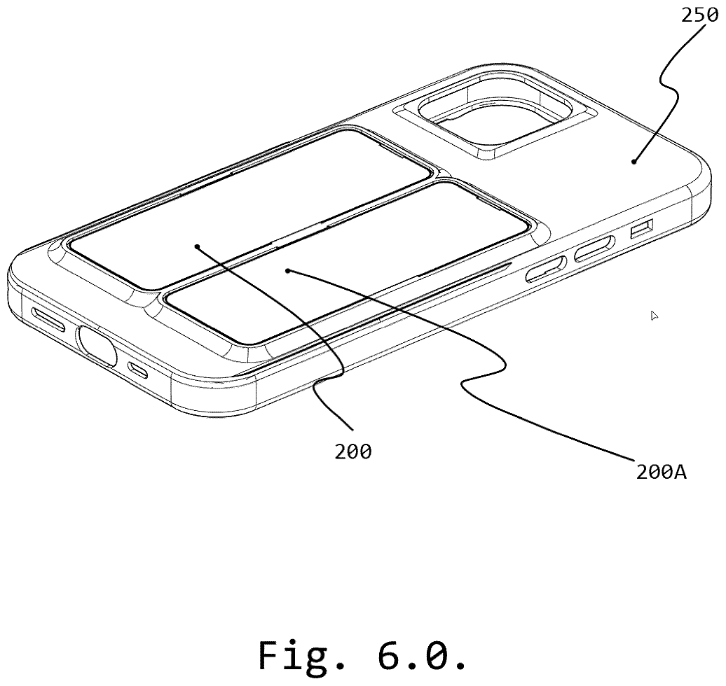

FIG. 6 is a perspective view of an alternate embodiment of the invention where two vehicle controlling devices 200, 200A are retained within the rear surface of a cell phone case thereby enabling a person who owns two vehicles to operate either one without the need of a key fob.

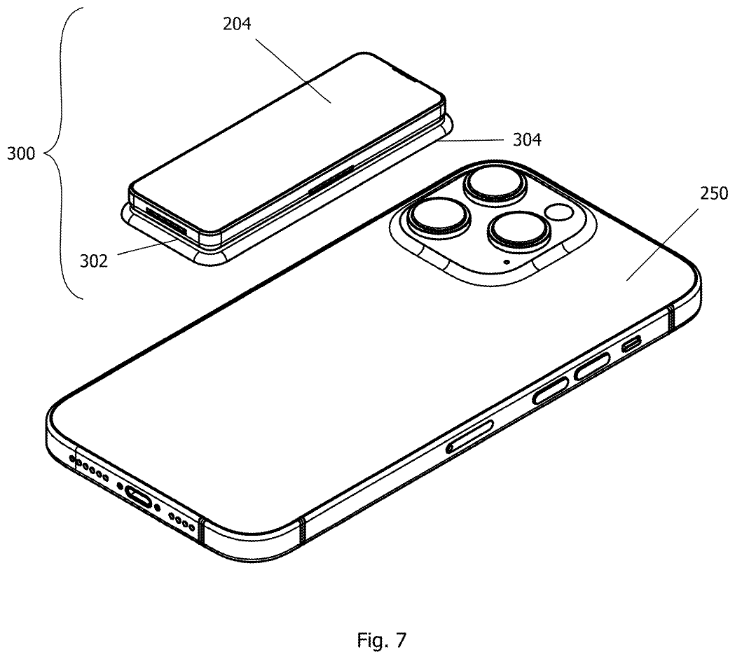

FIG. 7 is an exploded view of another alternate embodiment 300 where the bottom half 206A of the housing 200 includes a flange 304 that extends from all four sides of the bottom half housing. The flange 304 includes self-adhesive material 302 which allows the housing top half 204 to be inserted into an aperture 262 cut out of the rear of cell phone case 268. The flanges press up against the inside surface of the cell phone case 260 creating a similar final configuration as shown in the main embodiment of the invention. However, in this alternate embodiment 260 there is the option that a person can customize their existing cell phone case by cutting out a rectangular portion to create the aperture 262 and thereby eliminate the need to purchase a new cell phone case.

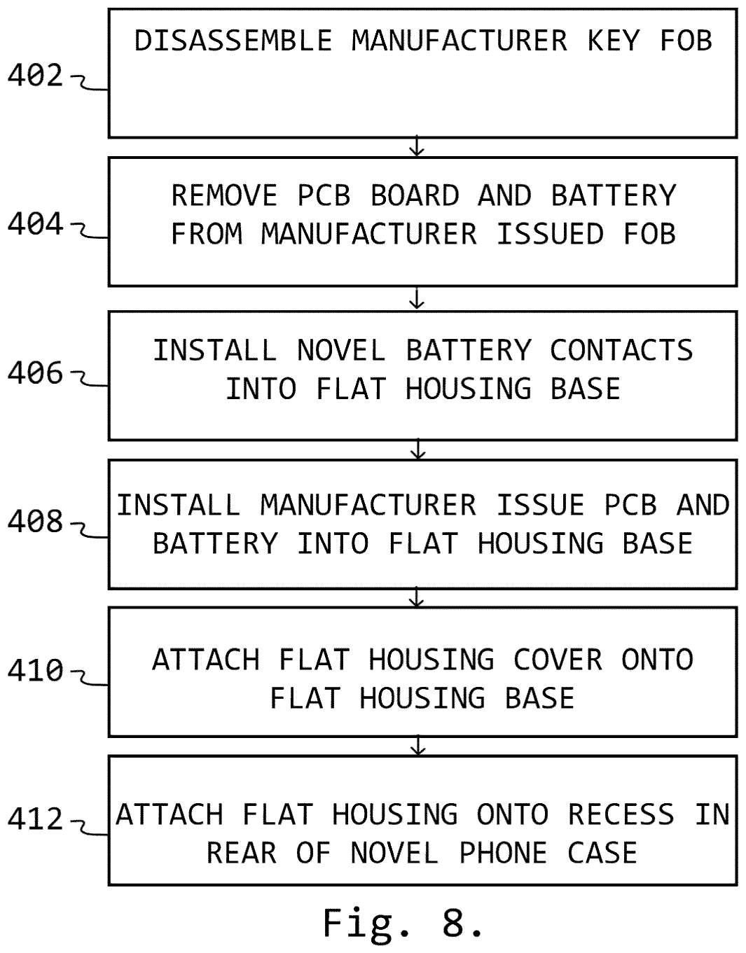

FIG. 8 is a flow chart showing the method, consisting of unique sequence of events needed to convert the manufacturer's key fob into the present invention. 402—The manufacturer's key fob is disassembled by the user or a designated professional. 404—The PC board and battery are removed from the key fob. 406—Custom battery contacts are installed in the bottom housing half. 408—The manufacturer's PC board and battery are installed in the bottom housing half. 410—Flat housing top half is attached to housing bottom half. 412—The flat housing of the present invention is inserted into a recess on the rear panel of a novel cell phone case.

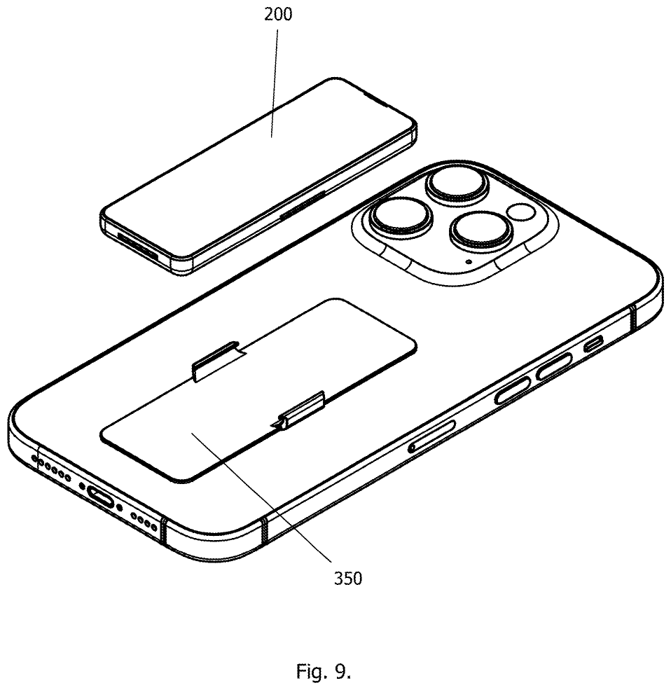

FIG. 9 is an exploded view of an alternate version of the invention where the flat fob housing 200 can be snapped into a retaining panel 250 via resilient side arms. The panel 250 is to be attached to a cell phone or cell phone case. By using this version, the user can use his own case without needing a special case.

It should be understood that terms cell phone, mobile phone and smart phone are referring to the same type of device as far as this application is concerned.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1-4. (canceled)

5. A process wherein a user creates a single cell phone-key fob device by combining a low profile key fob with a cell phone and/or a cell phone case enclosing the cell phone, wherein the cell phone and/or the cell phone enclosed in the cell phone case comprise means for securely holding at least one low profile key fob, the low profile key fob comprising an enclosure comprised of a top half and a bottom half, wherein furthermore both, the low profile key fob and the cell phone, retain their original functionality, wherein furthermore the low profile key fob can be detached from the cell phone and/or the cell phone enclosed in the cell phone case at will by the user without loss of functionality of the key fob and/or of the cell phone.

6. The process of claim 5 further comprising converting an original manufacturer's key fob into the low profile key fob, the original manufacturer's key fob comprising an enclosure enclosing at least a printed circuit board and a battery, wherein the converting process utilizes the original manufacturer's key fob enclosure enclosed printed circuit board and the original manufacturer's key fob enclosure enclosed battery, wherein the process of converting comprises:
a) disassembling the original manufacturer's key fob enclosure, removing the original manufacturer's enclosure enclosed printed circuit board and removing the original manufacturer's key fob enclosure enclosed battery;
b) inserting a low profile specific interconnecting contacts into the bottom half of the low profile key fob enclosure;
c) inserting the original manufacturer's printed circuit board into the bottom half and inserting the original manufacturer's key fob battery into the bottom half alongside the printed circuit board, wherein the battery and the printed circuit board are electrically connected by the low profile specific interconnecting contacts; and
d) attaching the top half to the bottom half whereby forming the low profile key fob.

7. The process of claim 5 wherein the cell phone case comprises a front and a back, the cell phone case front and the cell phone case back comprising an inside surface, the cell phone case inside surfaces facing the enclosed cell phone, whereby the cell phone comprises a front and a back, the cell phone back being proximate with the inside surface of the cell phone case back, the cell phone front and the cell phone back further comprising an outside surface facing outward from the cell phone, wherein the means for securely holding at least one low profile key fob comprise at least one of the following:
a) a single recessed portion disposed on the cell phone case back outside surface capable of snappably holding one low profile phone fob key;
b) two recessed portions side-by-side disposed on the cell phone case back outside surface, each portion capable of snappably holding one low profile phone-fob key;
c) a plurality of resilient tabs upwardly facing from a panel capable of snappably holding one low profile key fob, wherein the panel being attached to the back of the cell phone case, wherein furthermore the panel attachment means are selected individually or jointly from a group consisting of; and adhesive film and the panel being magnetic; and
d) a plurality of resilient tabs upwardly facing from a panel capable of snappably holding one low profile key fob wherein the panel being disposed on the cell phone back outside surface, wherein furthermore the panel attachment means are selected from a group consisting of; and adhesive film and the panel being magnetic.

8. The process of claim 5 wherein the low profile key fob comprises outwardly extending flanges disposed at the bottom half of the low profile key fob, wherein the outwardly extending flanges comprise attachment means selected individually or jointly from a group consisting of; and adhesive film and the panel being magnetic, whereby enabling the low profile key fob to be attached to the cell phone case, or directly to the back of the cell phone.
